(19) United States
(12) Patent Application Publication
(10) Pub. No.: US 2025/0244196 A1
(43) Pub. Date: Jul. 31, 2025

(54) JOINT LEAKAGE DETECTION SYSTEM

(71) Applicant: INTEGRITY ENGINEERING SOLUTIONS PTY LTD, Dunsborough (AU)

(72) Inventor: Ian Warren BROWN, Dunsborough (AU)

(21) Appl. No.: 18/854,774

(22) PCT Filed: Apr. 15, 2023
(86) PCT No.: PCT/AU2023/050310

§ 371 Date: Oct. 7, 2024

(30) Foreign Application Priority Data
Apr. 15, 2022 (AU) 2022901022

(51) Int. Cl. G01M 3/28

(52) U.S. Cl. CPC G01M 3/2853

(57) ABSTRACT

A leakage detection arrangement has a membrane sheet wrapping a pressure boundary joint. First and second adjustable bands tighten around the membrane sheet forming a gas enclosure around the joint. A gas flow arrangement enables gas flow into or out of the gas enclosure. Gas flow measuring arrangement signals indicate gas flow rate. An electronic control unit monitors the gas flow rate indicative signals and changes an output signal when the gas flow rate indicative signal varies beyond a predetermined amount. A leakage detection apparatus vacates or inflates the enclosure to a steady state pressure. Initial or baseline state can be recorded during steady state with pressure system depressurised. Pressure system can be pressurised and pressure and/or flow rate and/or other parameter(s) indicative of pressure or flow rate can be compared to the initial or baseline state. Any difference indicates leakage of the joint.

### TECHNICAL FIELD

The present invention relates to quality assurance for pressure boundary joints and in particular to leak detection for pressure boundary joints or pressure boundary bolted joints.

### BACKGROUND

Pressure boundary joints, also known as pressure boundary flanged joints, pressure boundary bolted joints or pressure boundary bolted flanged joints, are used to join two objects together to contain, in use, an internal pressure that is different to an external (usually atmospheric) pressure. The internal pressure can be a positive pressure or a vacuum (e.g., partial vacuum or negative pressure). Therefore, there is, in use, a pressure differential across the pressure boundary joint. Typically, a gasket is used between the two flanges of the objects to provide a joint seal. The American Association of Mechanical Engineers PCC-1 Guidelines for Pressure Boundary Bolted Flange Joint Assembly (ASME PCC-1-2022 being the current version having ISBN: 9780791875384) provides the industry standard for assembly of pressure boundary joints.

Currently leak tests are used as a method of quality assurance for pressure boundary joints and, in particular, pressure boundary bolted joints. The pressure vessel, piping or pipeline systems are filled with a gas or fluid and in some cases a gas containing a tracer gas (such as helium, hydrogen or halogen), pressurized and then leak tested by one of several varying means.

### BRIEF DESCRIPTION OF KNOWN ART

In the simplest form, the internal pressure is monitored and leakage determined by a pressure drop over time, as disclosed in U.S. Pat. No. 5,705,736. An alternative simple form is disclosed in U.S. Pat. No. 3,653,254, in which leakage is determined by fluid inflow into the system in order to maintain the pressure. These approaches have several disadvantages, the most significant including: the need to hold the pressure for a long period of time for a large pressure system; variation in pressure due temperature fluctuations during that period; and inability to locate which joints are leaking, should the test method indicate leakage.

The use of a tracer gas and gas leak detection via mass spectrometry or similar is disclosed in German patent number 3616319, International patent application publication numbers WO 2008/064964 and WO 2004/061404, U.S. Pat. No. 9,841,344 and Chinese patent application publication number 104568336A. This potentially allows for shorter test periods and inherently identifies which joints are leaking. However, access to each joint is necessary for the monitoring, there is a high cost associated with the expensive blending of the tracer and carrier gases, and due to variability of possible leak flow paths, the method becomes highly dependent on the position of the sensor versus the joint leak, resulting in false negative tests and leakage during operation. These methods also require an operator to be in close proximity to the pressurized piping, undesirably exposing them to risk of injury or death.

The flow path issue is improved by the use of tape to seal the gap between the outer diameter of the flanges. The tape is then pierced at several locations in order that the leak detector may be inserted. However, temporary leakage within the tape can lead to accumulation of the tracer gas, leading to high readings, which are then eliminated once the tape is removed and replaced, resulting in false positive indications of leakage if the tape is not removed and reinstalled. The tape also does not solve the leak flow path issue, as sensor location relative to the leak point and the tape hole locations still creates variability of reading, which is undesirable.

In addition, if the tape is accidentally left in place during operation, it may lead to an accumulation of leaking product and bolt degradation or an accumulation of moisture and associated corrosion of the joint component. It is therefore essential that the tape is removed, but it remains relatively easy to omit tape removal, resulting in potential catastrophic joint leakage during operation.

An example using tape is provided by U.S. Pat. No. 7,716,967 discloses a leak detector sleeve made of elastomeric material for a gas-tight seal when the leak detector sleeve encircles a flanged joint. The leak detector sleeve includes a hole that communicates with a gap in the flanged joint for the tip of a sniffer probe to be placed in or near the hole to detect whether the flanged joint is leaking.

An alternative to the use of tracer gas is to employ a soapy water test or similar on the joint once it is pressurised, as disclosed in U.S. Pat. Nos. 10,488,292 and 2,264,515 and United States patent application publication number 2014/0151242. This does not require the expensive tracer gas, but it is considered an order-of-magnitude less sensitive and is highly dependent on the skill of the operator applying and observing the formation of soapy water bubbles, rendering the method rarely used on large scale pressure systems.

Alternative methods, such as Volatile Organic Carbon (VOC) monitoring as disclosed in U.S. Pat. No. 9,588,084, or the use of a conductivity sensor in external sealed annulus as disclosed in U.S. Pat. Nos. 2,759,175, 7,960,978 and 8,289,173 are suitable in some scenarios, but suffer most of the same problems as mentioned previously and, in addition, do not allow the use of an inexpensive and non-reactive gas, such as nitrogen.

An alternative arrangement is disclosed in United States published patent document US2017082517A1 disclosing a leak identification system having a boundary containment system and a leak indicator system that enables identification of leaks within various systems. The disclosed boundary containment system is sealed around the pipes preventing any leakage from the flange assembly except through the leak indicator system at a pressure relief point.

WO 2020/141333 A1 discloses a bolted flange joint sealing and monitoring apparatus for monitoring the integrity of the seal around the structural bolted flange joints of wind turbines. As disclosed, a fault at one of the bolted flange joints is to be detected early so that the fault may be repaired to avoid putting strain on adjacent bolts of that joint.

An alternative that may be used in some scenarios are dual seal systems such as disclosed in European patent number 0 857 297, U.S. Pat. No. 4,019,371, and International patent application publication number WO 2002/071022. Another alternative scenarios are an external local pressure test as disclosed in U.S. Pat. No. 2,817,230 and an internal local pressure test as disclosed in U.S. Pat. Nos. 3,400,574 and 1,788,845.

However, these approaches do not stress the joint in the same manner as internal pressure and, therefore, are not considered effective in determining if a joint will leak during operation. In addition, for high pressure systems, it is difficult to achieve an adequate seal with the external or internal sealing system.

There have been previous attempts to resolve the above-mentioned problems by locally sealing just the outer diameter of the joint as disclosed in United States patent application publication number 2015/0268126, Canadian patent number 1 161 697, and U.S. Pat. Nos. 5,461,904 and 4,458,521, or in some cases the entire joint as disclosed in U.S. Pat. No. 2,766,614. In these previous cases, the presence of a leak is detected either visibly (collection of the leak material) or using one of the leak testing methods outlined above (in a similar manner to the commonly used tape).

The previous sealing systems and monitoring of pressure variation has proven to be ineffective, since it does not allow for variation in reading due to leakage past the seal between the enclosure and the joint or pipe outer diameter. In extreme cases, if the enclosure is not adequately sealed, then a significant joint leak may not be detected at all due to an alternative flow path past the sealing system. If an enclosure and sniffer test is used, as disclosed in U.S. Pat. No. 7,716,967, then that requires a flow past the detector to carry a tracer gas and the signal is affected by the rate of flow, which is in turn once again affected by the effectiveness of the enclosure seal. In addition, the enclosure seal leaks will affect the flow path of leak versus the sensor location, further influencing the readings.

It would therefore be desirable to provide a joint leakage detection arrangement that alleviates or overcomes one or more disadvantages of the known art, or at least provides an alternative.

### SUMMARY OF INVENTION

A first aspect of the present invention provides a leakage detection arrangement for a pressure boundary joint of a pressure system, the pressure boundary joint having at least a first outer diameter on a first body and a second outer diameter on a second body, the leakage detection arrangement including: a membrane sheet for wrapping around the joint; at least a first adjustable band or strap for tightening around at least the first outer diameter to form a substantially impermeable gas seal between the membrane sheet and the first body and at least a second adjustable band or strap for tightening around at least the second outer diameter to form a substantially impermeable gas seal between the membrane sheet and the second body; either: i. a pump to generate a negative pressure or a positive pressure, or ii. a pressurised gas source and a flow adjustment valve; a gas flow measuring arrangement for providing a signal indicative of gas flow rate; an output indicator having at least a first and a second state; and an electronic control unit for monitoring the signal indicative of gas flow rate, the electronic control unit changing the output indicator from the first state to the second state when the signal indicative of gas flow rate varies by more than a predetermined amount.

The negative pressure may be a partial vacuum. The pressurised gas source may include a gas cylinder, a compressor or an on-site supply of pressurised gas.

Another aspect of the present invention provides a leakage detection arrangement for a pressure boundary joint of a pressure system, the pressure boundary joint having at least a first outer diameter on a first body and a second outer diameter on a second body, the leakage detection arrangement including: a membrane sheet for wrapping around the joint; a first adjustable band and a second adjustable band; a gas flow arrangement for providing, in use, a flow of gas; a gas flow measuring arrangement for providing a signal indicative of gas flow rate; an output indicator; and an electronic control unit for monitoring the signal indicative of gas flow rate, the electronic control unit changing the output indicator when the signal indicative of gas flow rate varies by more than a predetermined amount.

The first outer diameter may be on a cylindrical outer surface on the first body. Similarly, the second outer diameter may be on a cylindrical outer surface on the second body.

The first adjustable band may be a first adjustable strap. Similarly, the second adjustable band may be a second adjustable strap.

Another aspect of the present invention provides a leakage detection arrangement for a pressure boundary joint of a pressure system, the pressure boundary joint having at least a first outer diameter on a first body and a second outer diameter on a second body, the leakage detection arrangement including: a membrane sheet for wrapping around the joint; a first adjustable band for tightening around the membrane sheet when, in use, the membrane sheet is wrapped around the joint, forming a first circumferential sealing edge under the band between the membrane and the first outer diameter; a second adjustable band for tightening around the membrane sheet when, in use, the membrane sheet is wrapped around the joint, forming a second circumferential sealing edge under the band between the membrane and the second outer diameter; the membrane and the first and second adjustable bands together forming, in use, a gas enclosure around the joint; a gas flow arrangement for providing, in use, a flow of gas into or out of the gas enclosure; a gas flow measuring arrangement for providing a signal indicative of gas flow rate; an output signal; and an electronic control unit for monitoring the signal indicative of gas flow rate, the electronic control unit changing the output signal when the signal indicative of gas flow rate varies by more than a predetermined amount.

The output signal may be a wired or wireless communication.

The first outer diameter may be on a first cylindrical outer surface on the first body; and the second outer diameter may be on a second cylindrical outer surface on the second body. Either or both the first and/or second cylindrical outer surface may be on a flange, or on an outer diameter of a tube, pipe, pressure vessel, instrument, valve connector or other pressurised portion or element of a piece of equipment.

The first outer diameter may be on a first body flange on the first body. Optionally, additionally the second outer diameter may be on a second body flange on the second body. In this example, the enclosure may be on the periphery of the flange. In this case the pressure boundary joint may preferably be a bolted flange joint or a flanged threaded joint.

Each of the first and second body flanges may include a respective annular sealing surface, a seal between the first and second body flange annular sealing surfaces results in a gap between the first and second body flanges. The gap may therefore be within the gas enclosure.

The pressure boundary joint may be a flanged joint including a first bolt flange on the first body and a second bolt flange on the second body, the first bolt flange being bolted to the second bolt flange by multiple bolts. Alternatively, the pressure boundary joint may be a threaded joint including a male threaded portion on the first body and a female threaded portion on the second body, the male threaded portion being engaged with the female threaded portion, in use. Alternatively, the pressure boundary joint may be a flanged joint including a first clamp flange on the first body and a second clamp flange on the second body, the first clamp flange being clamped to the second clamp flange by a flange connecting clamp.

In any of the three examples immediately above, the gas enclosure may completely envelope the pressure boundary joint. For example, the bolts, threaded joint or clamp may be within the enclosure. The first and/or second outer diameter may be an outer surface of a pipe or tube. Alternatively, or additionally, the first and/or second outer diameter may be a substantially cylindrical outer surface on a pressure vessel or instrument.

Alternatively, the first outer surface on the first body may be on a periphery of a flange on the first body, and the second outer surface on the second body may be on an outer diameter of a pipe or tube of the second body, or on a cylindrical portion on the second body. For example, the gas enclosure may be formed between the flange on the first body and a cylindrical surface on the second body (such as on an instrument) that is threaded or bolted to the first body.

The first body may be a pipe, tube, pressure vessel or instrument; and/or the second body may be a pipe, tube, pressure vessel or instrument.

When, in use, the membrane sheet is wrapped around the joint, a longitudinal seam may be formed, the membrane being rolled or folded onto itself to form a substantially gas impermeable seal. The longitudinal seam may be formed by the rolling and/or folding of the membrane.

The membrane sheet may be a gas impermeable membrane.

The gas enclosure may, in use, be substantially impermeable. A small amount of leakage may be preferable so that there is a small or minimal flow through the gas enclosure, either from atmosphere to the vacuum pump, or from the positive pressure pump to atmosphere, so that there is a small, but measurable flow rate through the gas enclosure.

The gas flow arrangement may be selected from: a vacuum pump; a positive pressure pump; a pressurised gas cylinder and a flow control valve; a source of pressurised gas at a regulated pressure; and a source of pressurised gas and a flow control valve.

The gas flow measuring arrangement may include at least one sensor selected from: a pump electrical current sensor; a pump speed sensor; a gas flow rate sensor; and a pressure sensor.

A unique identifier may be provided for the pressure boundary joint and/or the leak detection arrangement. For example, the unique identifier may enable the output signal to be associated with the pressure boundary joint. For example, the output signal may be a wired or wireless communication that includes the unique identifier which may include or be associated with GPS data or other location data such as obtained using wireless triangulation.

Another aspect of the present invention provides a method of detecting leakage from a pressure boundary joint of a pressure system, the pressure boundary joint having at least a first outer diameter on a first body and a second outer diameter on a second body, the method including: wrapping a sheet of membrane around the joint; tightening a first adjustable band around the membrane sheet, forming a first circumferential sealing edge under the band between the membrane and the first outer diameter; tightening a second adjustable band around the membrane sheet, forming a second circumferential sealing edge under the band between the membrane and the second outer diameter, such that the membrane and the first and second adjustable bands together form a gas enclosure around the joint; generating a pressure differential between the gas enclosure and atmosphere using a gas flow arrangement; measuring at least one parameter indicative of gas flow rate using a gas flow measuring arrangement and using said parameter to generate a respective gas flow rate indicative signal; monitoring the at least one gas flow rate indicative signal for a first period to obtain a steady state first gas flow rate, then monitoring the at least one gas flow rate indicative signal for a second period to obtain a steady state second gas flow rate; comparing the second gas flow rate with the first gas flow rate to obtain a change in gas flow rate; if the change in gas flow rate is less than a predetermined amount, providing an output indicating that the pressure boundary joint does not have a leak; if the change in gas flow rate is greater than a predetermined amount, providing an output indicating that the pressure boundary joint has a leak.

If the change in gas flow rate is less than the predetermined amount, the output may be triggered indicating that the pressure boundary joint is not leaking. If the change in gas flow rate is greater than the predetermined amount, the output may be triggered indicating that the pressure boundary joint has a leak. If the change in gas flow rate is greater than the predetermined amount, the output may be triggered indicating that the pressure boundary joint may have a possible leak and/or that the enclosure has a leak.

The gas flow arrangement may include a vacuum pump or a positive pressure pump, and the gas flow measuring arrangement may include at least one sensor selected from: a pump electrical current sensor; a pump speed sensor; a gas flow rate sensor; and a gas enclosure pressure sensor; and wherein the step of measuring at least one parameter indicative of gas flow rate may include measuring an output from said at least one sensor.

Alternatively, the gas flow arrangement may include a pressurised gas cylinder and an adjustable flow valve, and the gas flow measuring arrangement may include at least one sensor selected from: a gas flow rate sensor; and a gas enclosure pressure sensor; and wherein the step of generating a pressure differential between the gas enclosure and atmosphere may include adjusting the adjustable flow valve to generate a steady state first gas flow rate with a predetermined range. Additionally, the step of measuring at least one parameter indicative of gas flow rate may include measuring an output from said at least one sensor.

Alternatively, the gas flow arrangement may include a source of pressurised gas and a pressure regulator, and the gas flow measuring arrangement may include at least one sensor selected from: a gas flow rate sensor; and a gas enclosure pressure sensor, the step of generating a pressure differential between the gas enclosure and atmosphere including adjusting the pressure regulator to generate a steady state first gas flow rate with a predetermined range. For example, the step of measuring at least one parameter indicative of gas flow rate may include measuring an output from said at least one sensor.

The monitoring of the at least one gas flow rate indicative signal for the first period may be performed before the pressure system is pressurised. In this case, the first gas flow rate may be a baseline gas flow rate. The monitoring of the at least one gas flow rate indicative signal for the second period may be performed after the pressure system is pressurised. In this case, the second gas flow rate may be an operating gas flow rate. If a baseline and an operating gas flow rate are available, the step of comparing the second gas flow rate with the first gas flow rate to obtain a change in gas flow rate may include subtracting the baseline gas flow rate from the operating gas flow rate to obtain a possible leakage flow rate or at least to obtain a parameter indicative of a possible leakage flow rate.

When the output is triggered to indicate that the pressure boundary joint has a possible leak, the output may be latched or a flag may be set to enable the presence of a possible leak at the joint to be seen or received after it has been detected. For example, the output or flag can then be reset once the possible leak has been acknowledged or after the joint and/or the gas enclosure has been reviewed, reassembled or replaced. The output or flag must be reset prior to retesting the joint.

The method may include assigning a unique identifier to the pressure boundary joint. For example, the unique identifier may be, or may be associated with, a GPS location of the joint or other location related data such as obtained using wireless triangulation. The unique identifier may be transmitted with any data from the joint, such as sensor data or a triggered output indicating state of the pressure boundary joint.

### BRIEF DESCRIPTION OF DRAWINGS

### In the Drawings:

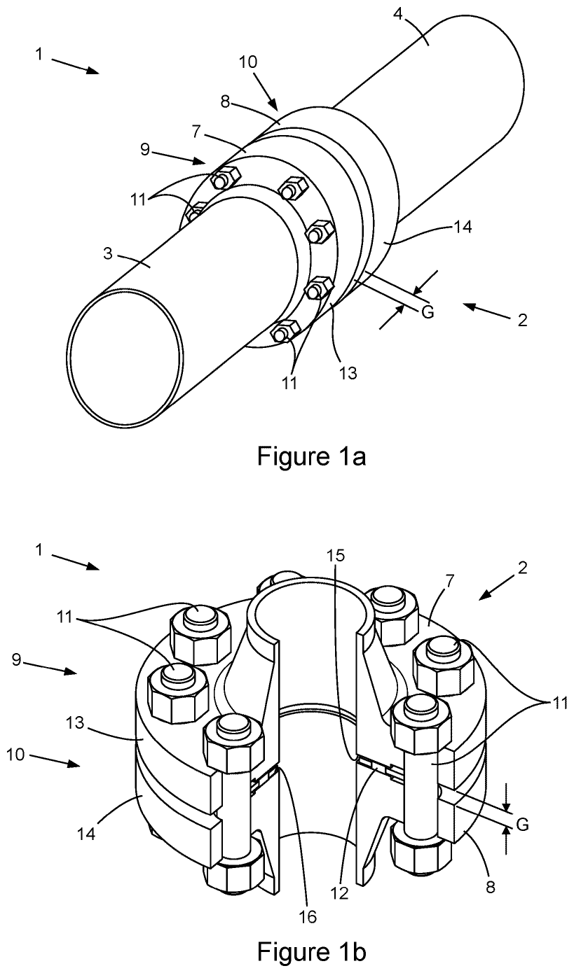

FIG. 1a shows a bolted flange pressure boundary joint.

FIG. 1b shows a partial section through a bolted flange pressure boundary joint.

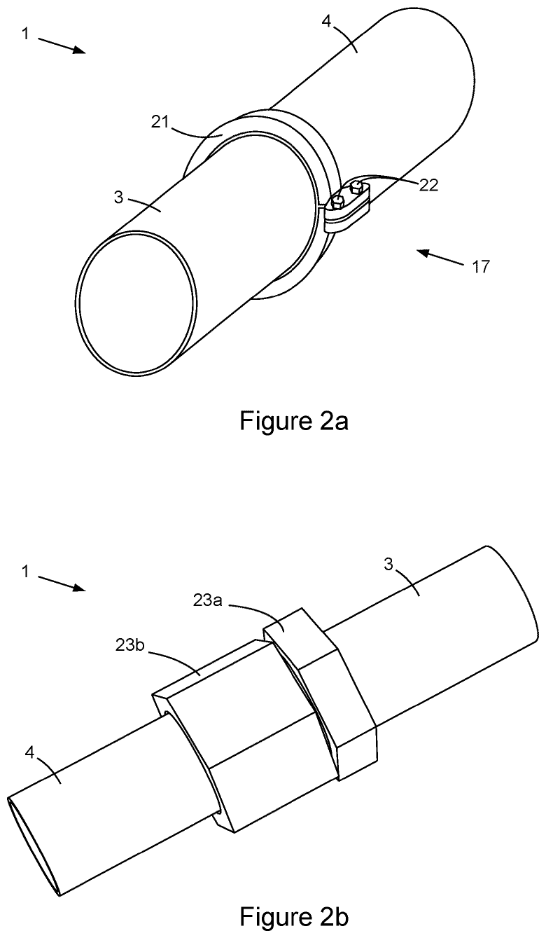

FIG. 2a shows a clamped flange pressure boundary joint.

FIG. 2b shows a threaded pressure boundary joint.

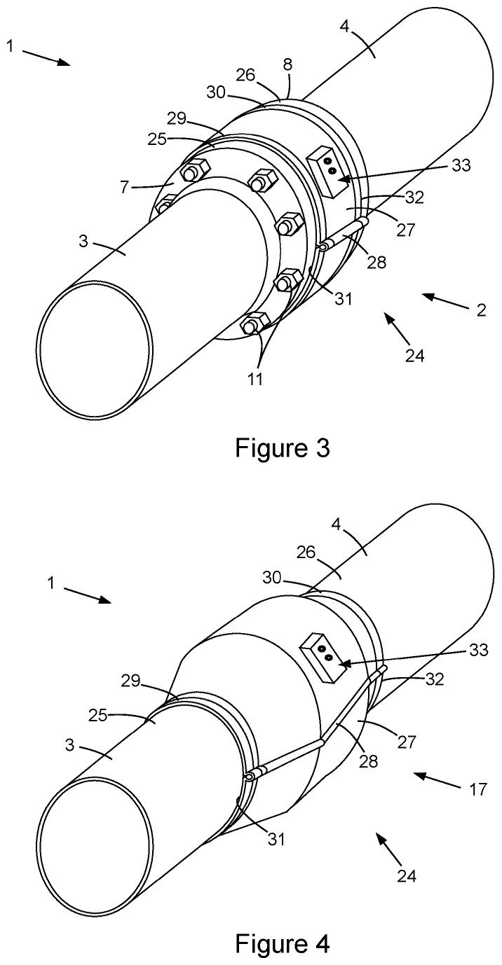

FIG. 3 shows a membrane of a leakage detection arrangement of an embodiment of the present invention, on the flanges of a pressure boundary joint.

FIG. 4 shows a membrane of a leakage detection arrangement of an embodiment of the present invention, enclosing a pressure boundary joint.

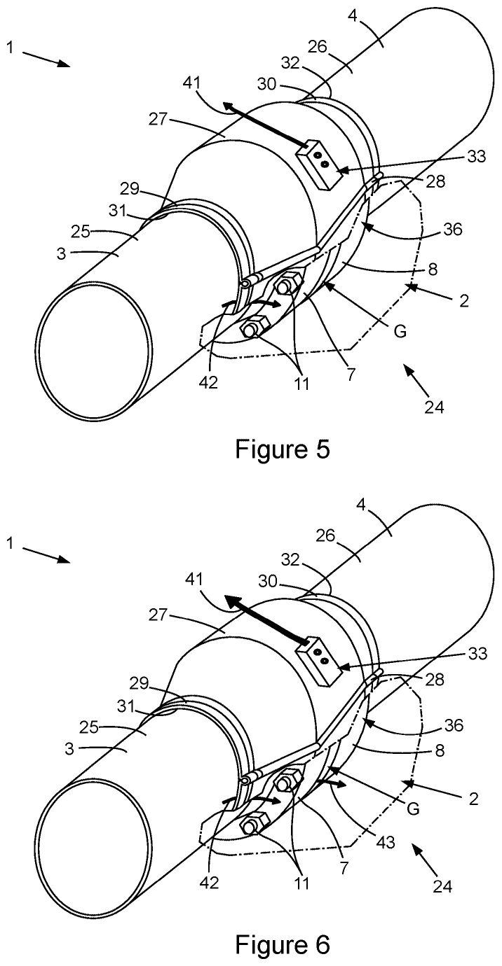

FIG. 5 shows a partial section view of the leakage detection arrangement of FIG. 4, with a vacuum in the gas enclosure.

FIG. 6 shows a partial section view of the leakage detection arrangement of FIGS. 4 and 5, with joint leakage.

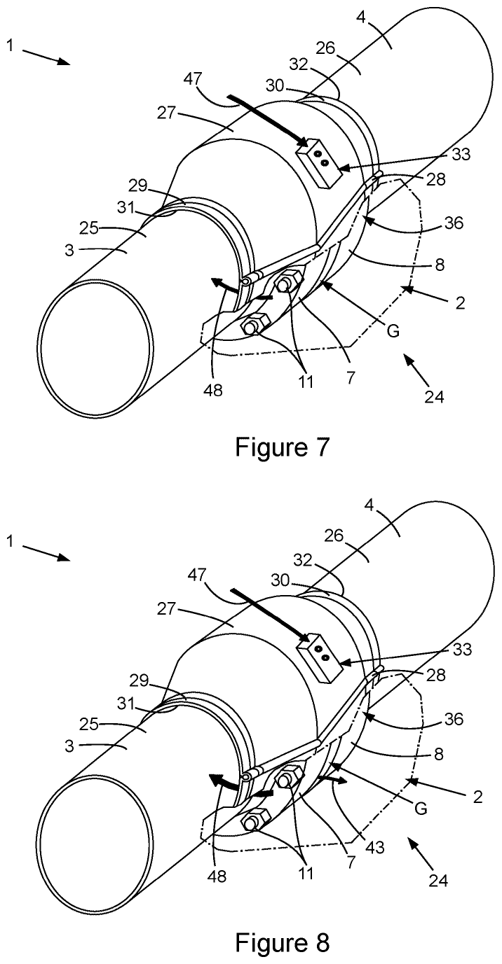

FIG. 7 shows a partial section view of the leakage detection arrangement of FIG. 4, with above atmospheric pressure in the gas enclosure.

FIG. 8 shows a partial section view of the leakage detection arrangement of FIGS. 4 and 7, with joint leakage.

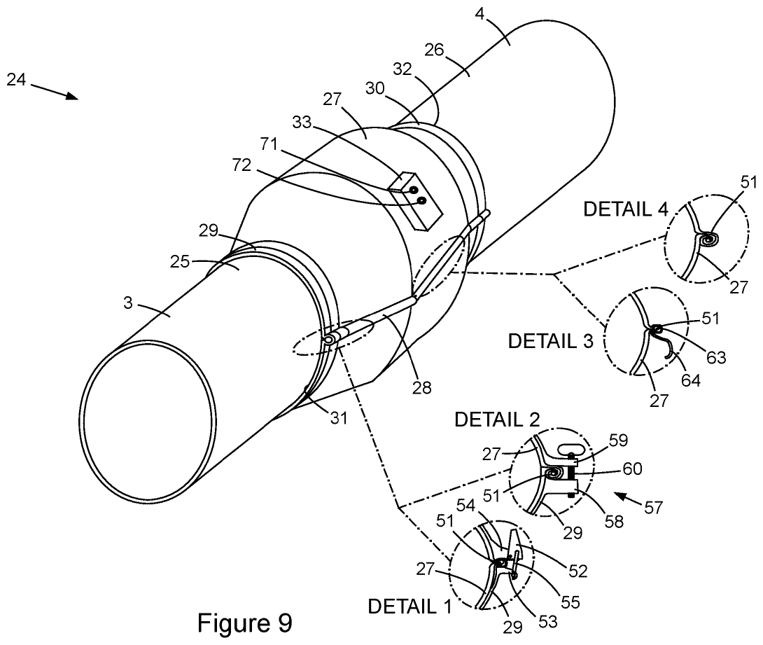

FIG. 9 shows the arrangement of FIG. 4 with multiple variations on the detailed configuration of the longitudinal joint.

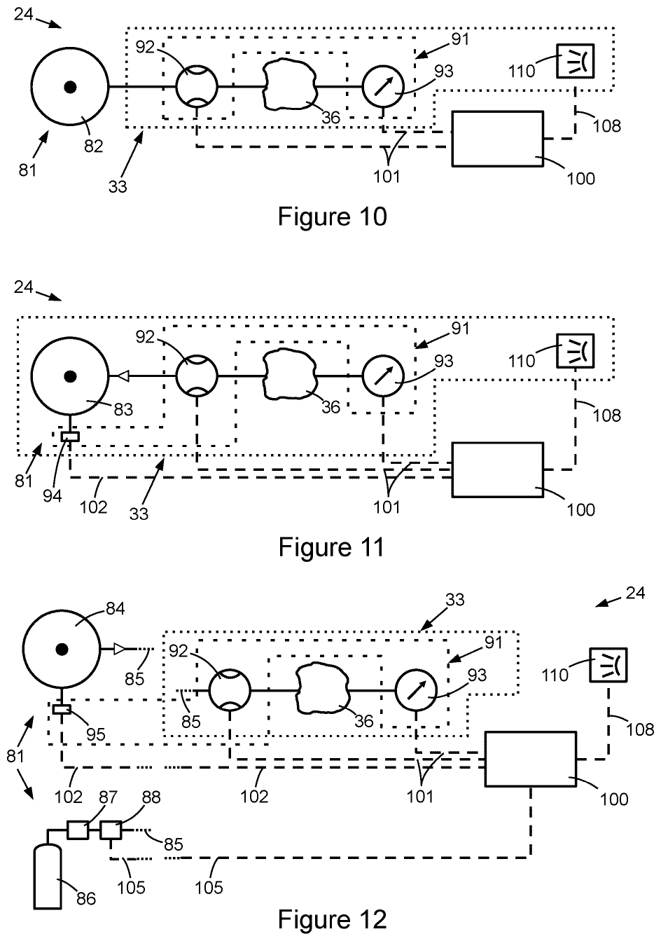

FIG. 10 shows a schematic diagram of a leakage detection arrangement according to one or more embodiments of the present invention.

FIG. 11 shows a schematic diagram of another leakage detection arrangement according to one or more embodiments of the present invention.

FIG. 12 shows a schematic diagram of a further leakage detection arrangement according to one or more embodiments of the present invention.

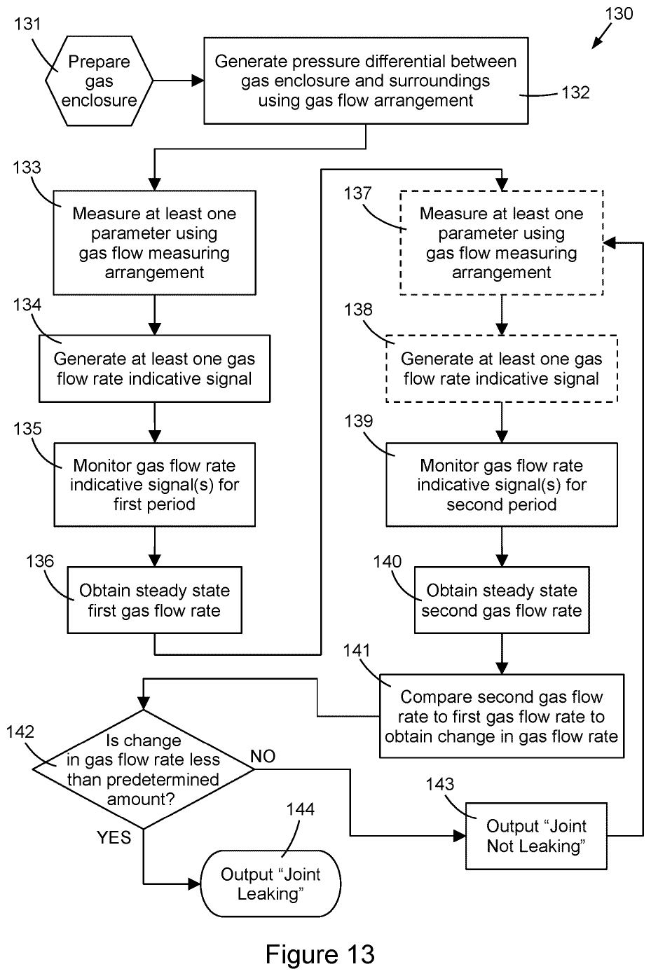

FIG. 13 shows a flow diagram of a method of one or more embodiments of the present invention.

### DESCRIPTION OF PREFERRED EMBODIMENT

Throughout the specification, common reference numerals are used to denote the same, similar or equivalent features. The first body can be a pipe, tube, pressure vessel, instrument, valve, connector or similar. The second body can be a pipe, tube, pressure vessel, instrument, valve, connector or similar.

Referring initially to FIGS. 1a and 2a there are shown two typical types of pressure boundary joint 1, for use within a pressure system, both of the illustrated typical pressure boundary joints being of the flanged type. In FIGS. 1a and 2a, the first body 3 and the second body 4 are both shown as pipes, although as noted above, they could be any form of tube or hose, pressure vessel, instrument, valve, connector or other pressurised equipment including at least one pressure boundary joint.

In FIG. 1a the first body flange 7 on the first body 3 and the second body flange 8 on the second body 4 are both visible and the flanges are drawn together using multiple bolts 11, so may be referred to as a first bolt flange 9 and second bolt flange 10 of a bolted flange joint.

As can be seen in FIG. 1b, the bolts 11 clamp a seal 12 such as a gasket between the first and second body flanges 7 and 8, leaving a gap ‘G’ visible between the flanges 7 and 8. The seal is located between a first annular sealing surface 15 on the first body flange 7 and a second annular sealing surface 16 on the second body flange 8.

If the joint leakage arrangement is going to seal at or fix to the flanges, then the outer diameter of the first body flange 7 or first bolt flange 9 is a first outer diameter 13, and the outer diameter of the second body flange 8 or second bolt flange 10 is a second outer diameter 14. These outer diameters of the first and second body flanges are typically the periphery of each respective flange.

In FIG. 2a, the pressure boundary joint 1 is a clamped flange joint 17. The flanges (not visible) on the first and second bodies 3, 4 can be shaped differently to facilitate being clamped together using the connecting clamp 21, so may be referred to as a clamp first flange on the first body 3 and a clamp second flange on the second body 4. However, once the connecting clamp 21 is around the first and second clamp flanges, as shown in FIG. 2a, those clamp flanges are not easily visible in FIG. 2a. The connecting clamp 21 is fastened by clamp bolts 22.

FIG. 2b shows male and female thread type joint where the female threaded portion 23b of the second body 4 is able to be turned relative to the pipe or tube portion and has a hexagonal outer feature to enable tightening. The female thread is not visible in FIG. 2a as it is located inside the hexagonal outer feature of the female threaded portion 23b. The male threaded portion 23a of the joint is fixed to the first body 3 with a hexagonal portion being provided to enable the female portion to be tightened to it. The male thread is not visible in FIG. 2a as it is located inside the hexagonal outer feature of the female threaded portion 23b.

If the flanges, such as the first and second body flanges 7, 8 of FIG. 1a, present a suitable first and second outer diameter 13, 14 either side of a gap G, then as shown in FIG. 3, the first and second outer diameters can provide a first cylindrical outer surface 25 and a second cylindrical outer surface 26 around which a sheet of membrane 27 can be wrapped, enclosing the gap (not visible) and forming an enclosure of a leakage detection arrangement 24. Due to the clamping force seating the bolts 11 and nuts against the first and second body flanges 7, 8, the leakage from the enclosure through the bolt holes is assumed to minor, so while not necessarily negligible, should be low enough to allow a pump or other device of the leakage detection arrangement 24 arrangement to maintain a pressure differential between the enclosure and the outside (atmosphere).

Where the ends of the sheet of membrane overlap, they are folded onto themselves or rolled tightly together to form a longitudinal seam 28 to substantially prevent leakage. At or near the first end of the enclosure, a first circumferential sealing edge 31 is formed between the membrane and the first outer diameter or first cylindrical outer surface 25 of the first body flange 7 by using a first adjustable band 29 to tie or clamp the membrane to the first body flange 7. Similarly, at or near the second end of the enclosure, a second circumferential sealing edge 32 is formed between the membrane and the second outer diameter or second cylindrical outer surface 26 of the second body flange 8 by using a second adjustable band 30 to tie or clamp the membrane to the second body flange 8. The first and second circumferential sealing edges 31, 32 define the outside ends of the gas enclosure.

A leakage detection apparatus (which may be or may include a leakage detection unit) is then used to vacate or inflate the enclosure to reach a steady state pressure inside the enclosure, with monitoring of the pressure in the enclosure, or a flow rate through the leakage detection apparatus, or other parameters indicative of the pressure or flow rate. If a steady state is reached, with the pressure system de-pressurised, then that initial or baseline state can be recorded, then the pressure system can be pressurised, for example to an operating pressure. The pressure and/or flow rate and/or any other parameter indicative of pressure or flow rate, can be compared to the parameter(s) of the initial or baseline state, where any difference can indicate leakage of the pressure boundary joint 1.

In FIG. 3, the leakage detection apparatus 33 can include at least a portion of the leakage detection apparatus 33 on the membrane 27 to connect the enclosure to means to vacate or inflate the enclosure 36. The portion of the leakage detection apparatus 33 can also include sensors for pressure and/or flow rate and can optionally also include an electronic control unit and at least one output indicator to show the status of the leakage detection arrangement and/or the pressure boundary joint.

An alternative enclosure for the leakage detection arrangement 24 is shown in FIG. 4. In this case, the membrane 27 encloses the entire joint, so can be used on all types of pressure boundary joints 1 including the clamped flange joint 17 of FIG. 2. If used on the bolted flange joint of FIG. 1, any variability caused by leakage through the bolt holes can be eliminated, although it is possible that the smaller membrane of FIG. 3 might be preferred for simplicity for bolted flanged joints.

With the membrane 27 wrapped around the pressure boundary joint, the overlapping ends of the sheet of membrane are folded onto themselves or rolled tightly together to form a longitudinal seam 28 to substantially prevent leakage. At or near the first end of the enclosure, a first circumferential sealing edge 31 is formed between the membrane 27 and the first outer diameter or first cylindrical outer surface 25 of the first body 3 by using a first adjustable band 29 to tie or clamp the membrane to the first body 3. Similarly, at or near the second end of the enclosure, a second circumferential sealing edge 32 is formed between the membrane 27 and the second outer diameter or second cylindrical outer surface 26 of the second body 4 by using a second adjustable band 30 to tie or clamp the membrane to the second body 4. The first and second circumferential sealing edges 31, 32 define the outside ends of the gas enclosure.

The leakage detection apparatus would be connected and operated as described for FIG. 3 and the portion of the leakage detection apparatus 33 is again provided on the membrane of FIG. 4 to connect the enclosure to means to vacate or inflate the enclosure.

The portion of the leakage detection apparatus 33 can optionally also include sensors for pressure 93 and/or flow rate 92 and can optionally further include an electronic control unit 100 and at least one output indicator 110 to show the status of the leakage detection arrangement and/or the pressure boundary joint. (Refer to FIGS. 10 to 12 and particular description below relating to the embodiments of FIGS. 10 to 12 for reference numeral concordance).

A section of the membrane 27 is cut away in FIG. 5 to show the inside of the gas enclosure 36, including the pressure boundary joint 1, which in this example is a bolted flange joint 2. As in FIG. 1, the flange 7 on the first body 3 and the flange 8 on the second body 4 are bolted together by multiple bolts 11. As explained above, the first and second body flanges 7 and 8 are typically held apart by a seal such as a gasket between the flange surfaces, leaving the gap G therebetween.

When the pressure system including the pressure boundary joint 1 is not pressurised, or when there is no leakage from the pressure boundary joint 1, then there is no joint leakage at the gap G. Gas flow 41 is drawn out of the enclosure at the portion of the leakage detection apparatus 33, by a vacuum pump for example, which will attempt to vacate the gas enclosure, but any minor leakage in the seals of the enclosure can cause gas flow into the enclosure bypassing the seals. For example, when the gas enclosure is at less than atmospheric pressure, or negative pressure, then there is a pressure drop from outside (or atmospheric) pressure to inside the gas enclosure 36. This pressure drop will be present across for example the first circumferential sealing edge 31 under the first adjustable band 29, so as illustrated by the arrow 42, gas can enter the enclosure where minor seal leakage points exist, such as the enclosure seal bypass flow 42. Other minor leakage may be present past the second circumferential sealing edge 32 or the longitudinal seam 28, but only the one minor leakage path is shown in this example.

As the minor leakage flow 42 into the gas enclosure is only minor, if it exists at all (i.e., it may be zero) then the pressure in the gas enclosure will reach a steady state or constant pressure. This would be a steady state or constant negative pressure. If a steady state or constant pressure less than atmospheric pressure (preferably by a minimum amount) cannot be achieved, then the membrane will need to be reapplied or at the very least the adjustable bands and/or the longitudinal seam adjusted to reduce the enclosure seal bypass flow 42 to be only a minor leakage flow such that the vacuum applied can hold a pressure in the gas enclosure that is at least a minimum magnitude below atmospheric pressure. This can be referred to as a minimum magnitude of negative pressure.

FIG. 6 shows the arrangement of FIG. 5 when the pressure system is pressurised and there is a leakage at the pressure boundary joint 1. The joint leakage flow 43 is shown from the flanged bolted joint 2, through the gap G, into the gas enclosure 36. The gas flow arrangement 81 is still drawing gas out of the gas enclosure, as shown by the arrow 41 showing flow drawn out, for example by a vacuum pump. (Refer to FIG. 10 and particular description below relating to the embodiment of FIG. 10 for reference numeral concordance for the gas flow arrangement 81). While the possible minor enclosure seal bypass flow 42 into the enclosure remains, the addition of the joint leakage flow 43 gives a higher flow out 41 of the enclosure 36, as shown by the wider arrow 41 in FIG. 6 compared to FIG. 5. This change in the flow out 41 is due to the joint leakage flow 43, so detecting the change (increase) in flow out 41 indicates joint leakage.

Conversely, instead of at least partially vacating the gas enclosure, as shown in FIGS. 5 and 6, the gas flow arrangement can inflate the gas enclosure as shown in FIGS. 7 and 8.

FIG. 7 is similar to FIG. 6 in showing the pressure boundary joint 1 enclosed by the gas enclosure 36, with the membrane being partially cut-away to show the joint within, in this example, a bolted flange joint 2. In FIG. 7, the pressure system is not pressurised, or the pressure boundary joint 1 is not leaking as there is no leakage at the gap G between the flanges 7 and 8 on the first and second bodies. However, in this example pressurised gas is supplied to the gas enclosure 36 via the portion of the leakage detection arrangement 33.

The flow of gas 47 into the gas enclosure 36 inflates the gas enclosure and provides a higher than atmospheric pressure, or positive pressure inside the gas enclosure, compared to the outside or atmospheric pressure outside the gas enclosure 36. Due to the pressure drop from the inside of the gas enclosure 36 to outside, any defect or weakness in the longitudinal seam 28 or across the first and second circumferential sealing edges 31, 32 under the first and second adjustable bands 29, 30 can cause a minor leakage flow 48 from inside the gas enclosure 36 to outside or to the atmosphere.

As the minor leakage flow 48 out of the gas enclosure should only be minor, if it exists at all (i.e. it may be zero), then the flow of gas 47 into the gas enclosure can be regulated to within a pre-set maximum flow, and if the leakage flow really is only minor, then the pressure in the gas enclosure will reach a steady state or constant pressure. This would be a steady state or constant positive pressure. If a steady state or constant pressure greater than atmospheric pressure (preferably by a minimum amount) cannot be achieved, then the membrane will need to be reapplied or at the very least the adjustable bands and/or the longitudinal seam adjusted to reduce the enclosure seal bypass flow 48 to be only a minor leakage flow such that the flow of gas 47 into the gas enclosure can hold a pressure in the gas enclosure that is at least a minimum magnitude above atmospheric pressure. This can be referred to as a minimum magnitude of positive pressure.

FIG. 8 shows the arrangement of FIG. 7 when the pressure system is pressurised and there is a leakage at the pressure boundary joint 1. The joint leakage flow 43 is shown from the flanged bolted joint 2, through the gap G, into the gas enclosure 36. The gas flow arrangement is still supplying gas pressure to the gas enclosure 36, as shown by the arrow 47 showing flow. While the possible minor enclosure seal bypass flow 48 out of the enclosure remains, the addition al pressure generated by the joint leakage flow 43 gives either a lower flow into the enclosure (shown by arrow 47 being narrower in FIG. 8 than FIG. 7) if enclosure pressure is regulated, and/or a higher enclosure seal bypass flow 48 out of the enclosure 36, (as shown by the wider arrow 48 in FIG. 8 compared to FIG. 7) if the supply pressure is regulated. Either way, the flow of gas 47 into the enclosure will reduce due to the joint leakage flow 43, so detecting the change (reduction) in flow of gas 47 into the gas enclosure indicates joint leakage.

FIG. 9 shows a membrane 27 forming a gas enclosure around a complete pressure boundary joint, thus being a portion of a leakage detection arrangement 24, similar to that shown in FIG. 4. Two adjustable band details are shown and two longitudinal seam details are shown.

Detail 1 shows an over-centre type latch 52. The first end of the adjustable band 29 includes a hook 53. The overlapping ends of the membrane 27 are rolled or folded and the roll of membrane 51 is captured between the hook 53 of the first end of the adjustable band and the second end of the adjustable band 54. The over-centre latch is pivoted on the second end of the adjustable band 54 and actuates a hook or loop 55 to draw the hook 53 of the first end of the adjustable band 29 towards the second end of the adjustable band 54. This action tightens the adjustable band 29 around the membrane 27 drawing it onto the body and helping to provide a seal. The action also can clamp the roll 51 of membrane to assist with the sealing on the longitudinal seam 28.

Detail 2 shows a screw clamp mechanism 57 on the adjustable band 29. The overlapping ends of the membrane 27 are rolled or folded and the roll of membrane 51 is captured between the first end of the adjustable band 58 and the second end of the adjustable band 59. A threaded adjuster 60, such as a screw, is used to draw the first and second ends 58, 59 of the adjustable band 29 together. This action tightens the adjustable band 29 around the membrane 27 drawing it onto the body and helping to provide a seal. The action also can clamp the roll 51 of membrane to assist with the sealing on the longitudinal seam 28.

Detail 3 shows a rod and clip arrangement to assist in securing and sealing the longitudinal seam 28. The overlapping ends of the membrane 27 are rolled around the rod 63, then the clip 64 can be either snapped around or slid onto the roll 51 of membrane and the rod 63. The longer the enclosure, the more such an arrangement may provide a better structure and seal of the longitudinal seam.

Detail 4 shows a roll 51 of the overlapping ends of the membrane. This roll of membrane can be folded as noted in any of details 1, 2 or 3. This type of seal is typical of dry-bags used for water sports, so is well-known. This type of seal can provide sufficient sealing across the longitudinal seam 28, especially when the seam is short, such as shown in FIG. 3 and the adjustable bands at the ends of the enclosure can also assist with holding the roll 51 of membrane at the functional ends (where the adjustable bands are located) of the longitudinal seam 28.

Indeed, the adjustable bands in the present invention can be ties, such as wire with the ends twisted together, or cable ties which can be of the reusable type to assist with removal without damaging the membrane. These comments and the preceding description of details 1 and 2 are applicable to either of the first and second bands.

The first band may be around the first body flange (on the first body) which can form the first cylindrical outer surface, and the second flange may be around the second body. The second body may be a pressure vessel or instrument. So for example, the first cylindrical outer surface around which the first adjustable band is tightened can be the first outer diameter of a first body flange. The second cylindrical outer surface around which the second adjustable band is tightened can be any suitable surface on the second body, from a pipe, to a cylindrical land on an instrument or pressure vessel.

In FIG. 9, the portion of the leakage detection arrangement 33 on the membrane 27 is shown with two output indicators 71, 72, such as different colour Light Emitting Diodes (LEDs) or similar. These can be used to show an initial pre-test steady state within an acceptable range of parameters has been achieved, and to show whether or not joint leakage has been detected once the leak test is underway and the pressure system is pressurised or operational.

FIG. 10 shows a diagram of an example of the leakage detection arrangement 24. The gas flow arrangement 81, shown as a pressure source 82 is connected to the gas enclosure 36 via a gas flow meter 92. The pressure inside the gas enclosure is detected by pressure sensor 93.

The gas flow meter 92 and the pressure sensor 91 can form part of the gas flow measuring arrangement 91. The parameters from the gas flow measuring arrangement 91 are transmitted to the electronic control unit 100 by communication links 101 which can provide wired or wireless communication. The electronic control unit 100 monitors the parameters from the gas flow measuring arrangement 91 and provides an output signal on the output signal communication link 108, which can be used to drive the output indicator 110. The sensors of the gas flow measuring arrangement 91 and the output indicator 110 can be provided in at least a portion of the leakage detection apparatus 33 which can be located on or adjacent to the gas enclosure 36.

As noted above the gas flow arrangement can be used to generate a (partial) vacuum or a negative pressure inside the gas enclosure, by vacating the gas enclosure. In this case the gas flow arrangement 81 can include a vacuum pump 83 as shown in FIG. 11. The vacuum pump can be provided for the leakage detection arrangements of one or more pressure boundary joints. If the vacuum pump is provided for the leakage detection arrangement of only one pressure boundary joint, then the pump speed can be monitored to detect the change in flow due to joint leakage. The pump speed can be communicated from a pump speed sensor 94 (or pump speed output) to the electronic control unit 100 by an additional communication link 102. When the vacuum pump is dedicated to the leakage detection arrangement on a single pressure boundary joint, the vacuum pump can be included in the leakage detection apparatus 33 on or adjacent the gas enclosure 36.

However, if the vacuum pump is used to generate a gas flow for multiple joint leakage detection arrangements, then the flow out of the enclosure and/or the pressure in the enclosure can be monitored to detect the change in flow due to joint leakage. FIG. 11 shows a gas flow measuring arrangement 91 including both a gas flow rate sensor 92 and a gas enclosure pressure sensor 93 as the flow out of the enclosure and/or the pressure in the enclosure can also be monitored when the vacuum pump is used to generate a gas flow for a single joint leakage detection arrangement.

Although in FIG. 11 the electronic control unit 100 is shown outside the leakage detection apparatus, it should be understood that the electronic control unit can be located inside the leakage detection apparatus. However, in this case the output signal communication link 108 can also provide wired and/or wireless communication of gas flow measuring arrangement parameters (such as from the gas flow rate sensor 92, the gas enclosure pressure sensor 93 and the pump speed sensor 94) to an external monitoring or control arrangement such as may be located in a site control room. The output communication link 108 can be unidirectional, from the electronic control unit to the control room, or bi-directional. When the link is bi-directional, the gas flow arrangement 81 such as the vacuum pump 82 can be controlled from a remote control room. The local output indicator 110 can optionally still be provided to enable visual identification of joint leaks at the joint location.

Alternatively, as also discussed above, the gas flow arrangement can be used to generate positive pressure inside the gas enclosure by inflating the gas enclosure. In this case, as shown in FIG. 12, the gas flow arrangement 81 can include a pump 84 (i.e., a positive pressure pump) or a source of pressurised gas such as a site supply or a gas bottle 86 to generate the flow along the conduit 85 into the gas enclosure. The conduit 85, between the fluid pressure source and the gas enclosure is shown broken as two possible forms of pressure source 81 are shown, either being connected to the gas enclosure. If a pump is used for a single joint leakage detection arrangement, then the pump speed or pump current (from pump current sensor 95) can be monitored to detect the change in flow due to joint leakage. Again, the additional communication conduit 102 is shown broken to indicate that it is optional as it can only be required when the pump 84 is used, not the gas cylinder 86.

However, if a source of pressurised gas is used, while the benefit can be that gas other than air can be used, such as nitrogen or other inert gas, it can be necessary to regulate the maximum supply pressure into the enclosure, or to control the supply controlled in dependence on a measured pressure within the gas enclosure. In FIG. 12, a pressure regulator 87 is shown in the conduit 85 from the gas cylinder 86 to the gas enclosure 36. The pressure regulator 87 can be used in series with a controllable valve 88. Controllable valve communication link 105 is provided between the electronic control unit and the controllable valve 88 to enable control of the controllable valve. The controllable valve 88 can be a flow control valve.

If the supply pressure is regulated, then it can be necessary to measure flow into the gas enclosure using flow rate sensor 92 and/or pressure in the gas enclosure using pressure sensor 93 to detect joint flow leakage. If the supply of pressurised gas is controlled in dependence on a measured pressure with the gas enclosure during an initial pre-test period when the pressure boundary joint is not leaking (such as when the pressure system is not pressurised), then when a steady state is reached of gas flow into the enclosure to maintain a desired base pressure, then when the system is pressurised, if the pressure in the gas enclosure increases, then joint leakage is indicated.

As noted above, a controllable valve such as a flow adjustment valve can be used in series with a pressure regulator on the supply of pressurised fluid. So, the pressure regulator can be used to limit the maximum pressure supplied, which can be used to limit the maximum pressure possible in the gas enclosure. The flow adjustment valve can be used to control the enclosure leakage rate to within desired bounds, i.e., more than a minimum enclosure leakage rate but less than a maximum enclosure leakage rate, to ensure that the enclosure leakage rate is a minor leakage flow.

While minor leakage flow past the circumferential seals and/or the longitudinal seam can be preferable but not essential, in all of the above cases (vacuum or pressure pump or pressurised gas supply) there exists a set of parameters (one or more of such parameters as pump speed, pump current draw and gas flow rate) that if exceeded, indicate that the enclosure is not adequately sealed. If that is the case, the enclosure seals should be adjusted or even the enclosure completely removed and refitted, possibly with the use of additional seal material if required, to achieve a level of sealing such that any minor leakage flow is below a maximum level at which the leakage detection method can operate in an optimal manner or with sufficient accuracy of leakage detection.

FIG. 13 shows a flow chart representative of a method 130 according to one or more embodiments of the present invention for detecting leakage from a pressure boundary joint of a pressure system. The pressure boundary joint has at least a first outer diameter on a first body and a second outer diameter on a second body, such as herein described according to one or more embodiments. The method can include: preparing a gas enclosure 131 (as referenced elsewhere herein), such as by wrapping a sheet of membrane around the joint; tightening a first adjustable band around the membrane sheet, forming a first circumferential sealing edge under the band between the membrane and the first outer diameter; tightening a second adjustable band around the membrane sheet, forming a second circumferential sealing edge under the band between the membrane and the second outer diameter, such that the membrane and the first and second adjustable bands together provide the gas enclosure around the joint.

The method 130 can include generating a pressure differential between the gas enclosure and atmosphere using a gas flow arrangement 132; measuring at least one parameter indicative of gas flow rate using a gas flow measuring arrangement 133 and using said parameter to generate a respective gas flow rate indicative signal 134; monitoring 135 the at least one gas flow rate indicative signal for a first period to obtain 136 a steady state first gas flow rate, (preferably/optionally measuring 137 at least one parameter using the gas flow measuring arrangement, and generating 138 at least one gas flow rate indicative signal), then monitoring 139 the at least one gas flow rate indicative signal for a second period to obtain 140 a steady state second gas flow rate; comparing 141 the second gas flow rate with the first gas flow rate to obtain a change in gas flow rate; a ‘joint leaking’ or ‘joint not leaking’ decision 142 is made: if the change in gas flow rate is less than a predetermined amount, triggering/providing 143 an output indicating that the pressure boundary joint does not have a leak; if the change in gas flow rate is greater than a predetermined amount, triggering/providing 144 an output indicating that the pressure boundary joint has or possibly has a leak.

The steps of measuring at least one parameter indicative of gas flow rate using a gas flow measuring arrangement 133 and using said parameter to generate a respective gas flow rate indicative signal 134 can be continuous; hence, repeating the steps of measuring 137 at least one parameter using the gas flow measuring arrangement and generating 138 at least one gas flow rate indicative signal can be superfluous—therefore being shown in dashed lines in FIG. 13. However, alternatively, the steps of measuring at least one parameter indicative of gas flow rate using a gas flow measuring arrangement 133 and using said parameter to generate a respective gas flow rate indicative signal 134 may be performed before the pressure system is pressurised, then the leakage detection arrangement can be used either for a set period after the pressure system is pressurised to check joint assembly, or periodically, such as for multiple periods to verify that no problem has developed at the joint over time. For example, the leakage detection arrangement may be maintained in place (in situ) and used to periodically verify that the joint is not leaking, the frequency of which can relate to the severity of failure effect of the joint. In such examples, the subsequent steps of measuring at least one parameter indicative of gas flow rate using a gas flow measuring arrangement 137 and using said parameter to generate a respective gas flow rate indicative signal 138 are performed once the pressure system is pressurised and are repeated to verify joint assembly or for on-going verification of joint integrity.

In some cases/embodiments, the enclosure may be fully gas tight, i.e. the minor leakage may be zero, but this can result in the leakage detection method being sub optimal. For example, if there is no minor leakage, such as past the circumferential seals, then if a pump is used, the pump could stall.

Operation of the leakage detection arrangement in the initial phase, where a steady state flow rate is achieved with zero joint leakage (such as when the pressure system is not pressurised) within acceptable parameters can be indicated by an output signal being transmitted, and/or an indicator (such as for example a yellow LED) on the enclosure or by observation or monitoring of one or more parameters such as enclosure pressure, pump speed or pump current draw. This can be done locally to the enclosure, if safe to do so, using hand-held devices for example to ensure the parameter(s) is within an acceptable range. It can also be monitored remotely.

A leakage detection arrangement, or the enclosures thereof, can be fitted to multiple or each of the joints in the pressure system, allowing identification of the level of leakage of each tested joint within the pressure system. This can be particularly beneficial if the initial or baseline state of preferably no leakage of each joint is achieved by measurement of each enclosure when the pressure system is de-pressurised.

With the enclosure(s) in place, and the or each of the enclosures tested to be within the desired or optimal range for the first or baseline steady state, they are then left in place with the gas flow arrangement of the leakage detection arrangement operational until the pressure system is pressurised to initiate the leak test.

Alternatively, the leakage detection system can be remotely stopped and started using wired or wireless signals, so once an enclosure has been installed and initially tested, it can be hibernated until a predetermined period before the leakage test, at which time it would be restarted, the predetermined period being chosen to ensure that the steady state baseline condition can be reached before the pressure system is (re-)pressurised.

During this initial pre-test operation period, leakage into the enclosure from the external atmosphere (when the gas enclosure is vacated) or leakage out of the enclosure into the external atmosphere (when the gas enclosure is inflated) is monitored either by pump speed (current draw or rpm) or internal gas enclosure pressure measurement. This allows a baseline of leak performance to be observed prior to the leak test and, if appropriate, adjustment to the enclosures to be made prior to system pressurization, which reduces personnel risk.

Once the leak test commences, the system is internally pressurised and is held for a period of time. If the joint is not leaking, then there is no change to the flow in and out of the enclosure and therefore the pump speed and enclosure internal pressure will not vary any more than the previous baseline reading. If any of the joints in the system are leaking, then the flow rate into those enclosures will be significantly affected by the leak rate past the joint gasket, with the total flow rate into the enclosure being the sum of the previous enclosure flow and the joint leakage flow, resulting in a pump speed or current change or a pressure fluctuation.

Any one or more of these changes in state (of pressure or of pump speed or current) can be detected electronically and, in the simplest form, used to trigger a change from an external green LED to an external red LED to indicate that particular joint has had leakage. Preferably, the motor speed or motor current draw or enclosure pressure, or some combination of these measures is relayed wirelessly (although wired connections are possible) to a test control system to be monitored such that the rate of fluctuation in enclosure pressure or pump speed and the timing of the fluctuation with regards to the applied internal leak pressure can be automatically compared and leakage flagged as soon as possible during the test, minimizing the test duration. This method removes the need for personnel in the vicinity of the test.

The pump speed can be a signal derived from or generated by the pump unit itself. For example, the pump may include at least four electrical or electronic connection wires or contacts. Similarly, the pump current could be monitored at the pump or as part of the pump unit, with a signal generated by the pump unit indicative of pump current. Alternatively, the pump may utilise PWM (Pulse Width Modulation) control so the speed measurement can be obtained from the pump's standard speed control system. Alternatively, the speed may be varied using a control system and the change in pressure may be measured. In that way a more accurate leakage rate can be determined, because when varying the pump speed and measuring the pressure at different speeds, the obtained trend line through the data points would be offset from an initial testing (baseline, possibly of the un-pressurised pressure system) to the actual operational leakage test, if the joint was leaking. Thus, by measuring at several different speeds, some variability and/or error can be eliminated.

Once either leakage is detected or the test hold period is exceeded, the pressure system may then be depressurised. This again offers an opportunity to confirm joint leakage, since the enclosure leakage should return to nominally the same baseline reading as prior to the test. If leakage has been detected, and the enclosure does not return to the nominal level, then this would indicate refitting the enclosure and retesting the system was appropriate.

This leakage detection arrangement may be also applied to an operating piping system or any pressure boundary joint of a pressure system which is at operating pressure, sensing pressure fluctuations during operation which indicate joint leakage.

The leakage detection arrangement can also utilise a unique identifier and/or GPS (Global Positioning System) tracking and/or wireless triangulation, to individually identify each joint and then to ensure all enclosures have been removed and are in stores prior to resumption of the normal operation of the pressure system if appropriate, (i.e. if a pressure boundary joint is not under longer term monitoring for leakage, as can be performed if required for high risk joints). Wireless triangulation can operate locally as opposed to GPS which uses satellites and requires the receiver to receive signals from four such satellites. Indeed, any means can be used to identify the location of the enclosure of a leakage detection arrangement because as noted, it is not only beneficial to provide the location of the joint being tested, but also for control of inventory.

The leakage detection arrangement can detect leakage using an inexpensive gas, such as nitrogen as noted above, but also can be used with a tracer gas. In that case, the enclosure facilitates sniffing of the gas at the enclosure exhaust. This has the advantage that the flow rate, and therefore detection sensitivity is closely controlled by the enclosure and the flow is drawn past the entire joint, minimizing variation in flow path.

Modifications and variations as would be apparent to a skilled addressee are deemed to be within the scope of the present invention.

It is to be understood that, if any prior art publication is referred to herein, such reference does not constitute an admission that the publication forms a part of the common general knowledge in the art, in Australia or any other country.

1. A leakage detection arrangement for a pressure boundary joint of a pressure system, the pressure boundary joint having at least a first outer diameter on a first body and a second outer diameter on a second body, the leakage detection arrangement including:
a membrane sheet for wrapping around the joint;
a first adjustable band for tightening around the membrane sheet when, in use, the membrane sheet is wrapped around the joint, forming a first circumferential sealing edge under the band between the membrane and the first outer diameter;
a second adjustable band for tightening around the membrane sheet when, in use, the membrane sheet is wrapped around the joint, forming a second circumferential sealing edge under the band between the membrane and the second outer diameter;
the membrane and the first and second adjustable bands together forming, in use, a gas enclosure around the joint;
a gas flow arrangement for providing, in use, a flow of gas into or out of the gas enclosure;
a gas flow measuring arrangement for providing a signal indicative of gas flow rate;
an output signal; and
an electronic control unit for monitoring the signal indicative of gas flow rate, the electronic control unit changing the output signal when the signal indicative of gas flow rate varies by more than a predetermined amount.

2. A leakage detection arrangement as claimed in claim 1 wherein the first outer diameter is on a first cylindrical outer surface on the first body; and
the second outer diameter is on a second cylindrical outer surface on the second body.

3. A leakage detection arrangement as claimed in claim 1 wherein the first outer diameter is on a first body flange on the first body, the second outer diameter is on a second body flange on the second body, and wherein each of the first and second body flanges includes a respective annular sealing surface, a seal between the first and second body flange annular sealing surfaces results in a gap between the first and second body flanges.

4.-5. (canceled)

6. A leakage detection arrangement as claimed in claim 1 wherein the pressure boundary joint is:
a flanged joint including a first bolt flange on the first body and a second bolt flange on the second body, the first bolt flange being bolted to the second bolt flange by multiple bolts; or
a threaded joint including a male threaded portion on the first body and a female threaded portion on the second body, the male threaded portion being engaged with the female threaded portion, in use; or
a flanged joint including a first clamp flange on the first body and a second clamp flange on the second body, the first clamp flange being clamped to the second clamp flange by a flange connecting clamp.

7.-8. (canceled)

9. A leakage detection arrangement as claimed in claim 6 wherein the gas enclosure completely envelopes the pressure boundary joint.

10. A leakage detection arrangement as claimed in claim 1 wherein the first outer surface on the first body is on a periphery of a flange on the first body, and the second outer surface on the second body is on an outer diameter of a pipe or tube of the second body, or on a cylindrical portion on the second body.

11. A leakage detection arrangement as claimed in claim 1 wherein the first body is a pipe, tube, pressure vessel or instrument; and/or
wherein the second body is a pipe, tube, pressure vessel or instrument.

12. A leakage detection arrangement as claimed in claim 1 wherein when, in use, the membrane sheet is wrapped around the joint, a longitudinal seam is formed, the membrane being rolled or folded onto itself to form a substantially gas impermeable seal.

13. A leakage detection arrangement as claimed in claim 1 wherein the membrane sheet is a gas impermeable membrane.

14. A leakage detection arrangement as claimed in claim 1 wherein the gas enclosure is, in use, substantially impermeable.

15. A leakage detection arrangement as claimed in claim 1 wherein the gas flow arrangement is selected from:
a vacuum pump;
a positive pressure pump;
a pressurised gas cylinder and a flow control valve;
a source of pressurised gas at a regulated pressure; and
a source of pressurised gas and a flow control valve.

16. A leakage detection arrangement as claimed in claim 1 wherein the gas flow measuring arrangement includes at least one sensor selected from:
a pump electrical current sensor;
a pump speed sensor;
a gas flow rate sensor; and
a pressure sensor.

17. A leakage detection arrangement as claimed in claim 1 wherein a unique identifier is provided for the pressure boundary joint and/or the leak detection arrangement.

18. A method of detecting leakage from a pressure boundary joint of a pressure system, the pressure boundary joint having at least a first outer diameter on a first body and a second outer diameter on a second body, the method including:
wrapping a sheet of membrane around the joint;
tightening a first adjustable band around the membrane sheet, forming a first circumferential sealing edge under the band between the membrane and the first outer diameter;
tightening a second adjustable band around the membrane sheet, forming a second circumferential sealing edge under the band between the membrane and the second outer diameter, such that the membrane and the first and second adjustable bands together form a gas enclosure around the joint;
generating a pressure differential between the gas enclosure and atmosphere using a gas flow arrangement;
measuring at least one parameter indicative of gas flow rate using a gas flow measuring arrangement and using said parameter to generate a respective gas flow rate indicative signal;
monitoring the at least one gas flow rate indicative signal for a first period to obtain a steady state first gas flow rate, then monitoring the at least one gas flow rate indicative signal for a second period to obtain a steady state second gas flow rate;
comparing the second gas flow rate with the first gas flow rate to obtain a change in gas flow rate;
if the change in gas flow rate is less than a predetermined amount, providing an output indicating that the pressure boundary joint does not have a leak;
if the change in gas flow rate is greater than a predetermined amount, providing an output indicating that the pressure boundary joint has a leak.

19. The method as claimed in claim 18, wherein the gas flow arrangement includes a vacuum pump or a positive pressure pump, and
the gas flow measuring arrangement includes at least one sensor selected from:
a pump electrical current sensor;
a pump speed sensor;
a gas flow rate sensor; and
a gas enclosure pressure sensor; and wherein
the step of measuring at least one parameter indicative of gas flow rate includes measuring an output from said at least one sensor.

20. The method as claimed in claim 18, wherein the gas flow arrangement includes a pressurised gas cylinder and an adjustable flow valve, and
the gas flow measuring arrangement includes at least one sensor selected from:
a gas flow rate sensor; and
a gas enclosure pressure sensor,
the step of generating a pressure differential between the gas enclosure and atmosphere including adjusting the adjustable flow valve to generate a steady state first gas flow rate with a predetermined range.

21. The method as claimed in claim 18, wherein the gas flow arrangement includes a source of pressurised gas and a pressure regulator, and
the gas flow measuring arrangement includes at least one sensor selected from:
a gas flow rate sensor; and
a gas enclosure pressure sensor,
the step of generating a pressure differential between the gas enclosure and atmosphere including adjusting the pressure regulator to generate a steady state first gas flow rate with a predetermined range.

22. The method as claimed in claim 18, wherein the monitoring of the at least one gas flow rate indicative signal for the first period is performed before the pressure system is pressurised, the first gas flow rate being a baseline gas flow rate, and
wherein the monitoring of the at least one gas flow rate indicative signal for the second period is performed after the pressure system is pressurised, the second gas flow rate being an operating gas flow rate.

23. The method as claimed in claim 18, wherein when the output is provided to indicate that the pressure boundary joint has a leak, the output is latched or a flag is set to enable the presence of a possible leak at the joint to be seen or received after it has been detected.

24. The method as claimed in claim 18, wherein the method includes assigning a unique identifier to the pressure boundary joint.
